(19) United States
(12) Patent Application Publication
(10) Pub. No.: US 2024/0029936 A1
(43) Pub. Date: Jan. 25, 2024

(54) MAGNETIC COMPONENT

(71) Applicant: CYNTEC CO., LTD., Hsinchu (TW)

(72) Inventors: Hsin-Jung Cheng, Hsinchu (TW); Po-Hsiu Chien, Hsinchu (TW); Yung-Shou Hsu, Hsinchu (TW); Hun-Neng Chen, Hsinchu (TW); Hsieh-Shen Hsieh, Hsinchu (TW)

(73) Assignee: CYNTEC CO., LTD., Hsinchu (TW)

(21) Appl. No.: 18/223,034

(22) Filed: Jul. 18, 2023

Related U.S. Application Data
(60) Provisional application No. 63/390,972, filed on Jul. 21, 2022.

(51) Int. Cl. H01F 27/08; H01F 27/24; H01F 27/30

(52) U.S. Cl. CPC H01F 27/08; H01F 27/24; H01F 27/306

(57) ABSTRACT

A magnetic component includes a core, at least one coil and a thermal conductive filler. The core includes an inner leg, at least two outer legs and at least one non-bonding region. The at least one coil is wound around the inner leg or the at least two outer legs. The thermal conductive filler covers a part of the core. At least one part of the at least one non-bonding region is not covered by the thermal conductive filler.

### CROSS REFERENCE TO RELATED APPLICATIONS

This application claims the benefit of U.S. Provisional Application No. 63/390,972, filed on Jul. 21, 2022. The content of the application is incorporated herein by reference.

### BACKGROUND OF THE INVENTION

### 1. Field of the Invention

The invention relates to a magnetic component and, more particularly, to a magnetic component capable of reducing thermal stress of a core.

### 2. Description of the Related Art

In response to the demand for fast charging of electric vehicles, the operating power is getting bigger and bigger, such that the heat generated by electronic components is also getting higher and higher. A magnetic component of an on-board charger (OBC), such as transformer, will generate heat due to loss during operation, and the uneven heat will generate additional thermal stress on a core of the transformer. The thermal stress will increase the loss of the core of the transformer, and the heat will not converge under continuous cycles, thereby resulting in excessively high temperature and loss. Consequently, it will cause irreversible damage to the core in severe cases.

### SUMMARY OF THE INVENTION

The invention provides a magnetic component capable of reducing thermal stress of a core, so as to solve the aforesaid problems.

According to an embodiment of the invention, a magnetic component comprises a core, at least one coil and a thermal conductive filler. The core comprises an inner leg, at least two outer legs and at least one non-bonding region. The at least one coil is wound around the inner leg or the at least two outer legs. The thermal conductive filler covers a part of the core. At least one part of the at least one non-bonding region is not covered by the thermal conductive filler.

According to another embodiment of the invention, a magnetic component comprises a core, at least one coil and a thermal conductive filler. The core comprises an inner leg, at least two outer legs and at least one non-bonding region. The at least one non-bonding region is located at the at least two outer legs. The at least one coil is wound around the inner leg or the at least two outer legs. The thermal conductive filler covers a part of the core and the at least one non-bonding region located at the at least two outer legs.

According to another embodiment of the invention, a magnetic component comprises a core, a bobbin, at least one coil and a thermal conductive filler. The core comprises an inner leg, at least two outer legs and a plurality of non-bonding regions. The plurality of non-bonding regions are located at the inner leg and the at least two outer legs. The bobbin is sleeved on the inner leg. An upper surface of the bobbin is bonded to an inner plate surface of the core. The at least one coil is disposed on the bobbin. The thermal conductive filler covers a part of the core and does not cover the plurality of non-bonding regions.

According to another embodiment of the invention, a magnetic component comprises a core, at least one spacer and at least two coils. The core comprises an inner leg and at least two outer legs. The at least two coils and the at least one spacer are stacked with each other and directly sleeved on the inner leg. Each of the at least two coils is formed by winding a wire covered by at least three misaligned layers of insulating tape.

As mentioned in the above, in an embodiment, the at least one non-bonding region may be located at the inner leg or the at least two outer legs, and at least one part of the at least one non-bonding region may not be covered by the thermal conductive filler. Accordingly, the inner leg or the at least two outer legs with the non-bonding region can deform freely while the temperature difference (or max temperature) of the core increases, such that the thermal stress of the core can be reduced to prevent the loss of the core from increasing. Furthermore, in another embodiment, the at least one non-bonding region may be located at the at least two outer legs, and the thermal conductive filler may cover the at least one non-bonding region. Similarly, the at least two outer legs with the non-bonding region can deform freely while the temperature difference (or max temperature) of the core increases, such that the thermal stress of the core can be reduced to prevent the loss of the core from increasing. In another embodiment, the coil and the spacer may be stacked with each other and directly sleeved on the inner leg of the core, such that the coil does not need to be wound to a bobbin, so as to improve the effects of insulation and heat dissipation between the primary coil and the secondary coil and between the coil and the core. Accordingly, the magnetic component does not need to be limited by the size and space of the bobbin, and the spacer may be tightly in contact with the coil, or a structure of the coil cover may extend between two coils to fix and minimize a distance and a gap between the spacer and the coils, so as to minimize the size of the magnetic component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional view illustrating a magnetic component according to an embodiment of the invention.

FIG. 2 is a sectional view illustrating the magnetic component according to another embodiment of the invention.

FIG. 3 is an exploded view illustrating a spacer, a coil cover and two coils shown in FIG. 2.

FIG. 4 is a schematic view illustrating four spacers in different shapes.

FIG. 5 is a schematic view illustrating a wire covered by three misaligned layers of insulating tape.

FIG. 6 is a perspective view illustrating a magnetic component according to another embodiment of the invention.

FIG. 7 is a sectional view illustrating the magnetic component shown in FIG. 6.

FIG. 8 is another sectional view illustrating the magnetic component shown in FIG. 6.

FIG. 9 is a perspective view illustrating the bobbin shown in FIG. 7.

FIG. 10 is a top view illustrating the bobbin shown in FIG. 9.

FIG. 11 s a sectional view illustrating a magnetic component according to another embodiment of the invention.

FIG. 12 is a sectional view illustrating a magnetic component according to another embodiment of the invention.

FIG. 13 is a sectional view illustrating a magnetic component according to another embodiment of the invention.

FIG. 14 is a perspective view illustrating a magnetic component according to another embodiment of the invention.

FIG. 15 is a perspective view illustrating the magnetic component according to another embodiment of the invention.

### DETAILED DESCRIPTION

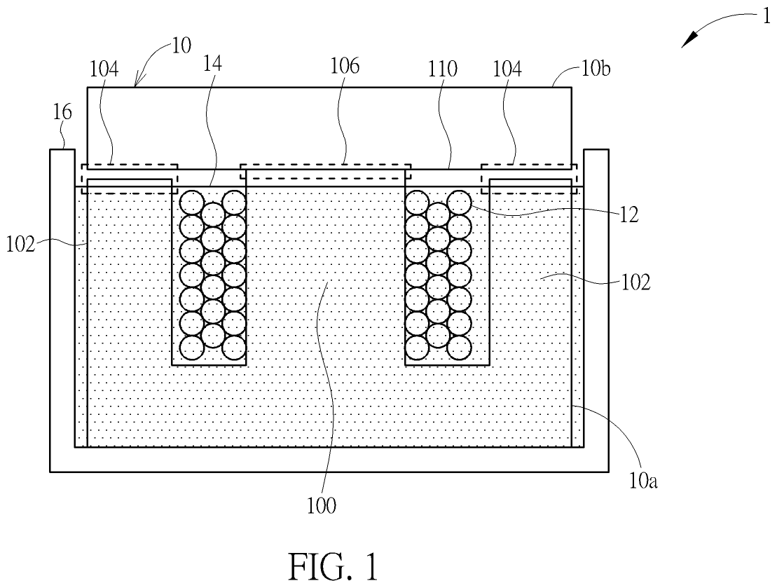

Referring to FIG. 1, FIG. 1 is a sectional view illustrating a magnetic component 1 according to an embodiment of the invention.

The magnetic component 1 of the invention may be a reactor, a transformer, an inductor or other magnetic components. As shown in FIG. 1, the magnetic component 1 comprises a core 10, at least one coil 12 and a thermal conductive filler 14. The core 10 comprises an inner leg 100, at least two outer legs 102, at least one non-bonding region 104 and at least one bonding region 106. In this embodiment, the core 10 may comprise a first core member 10a and a second core member 10b, wherein the inner leg 100 may be a central pillar extending from the center of the first core member 10a and two outer legs 102 may be side pillars extending from the periphery of the first core member 10a. Thus, in this embodiment, the first core member 10a may be an E core, PQ core, T core or F core and the second core member 10b may be an I core, UU core, U core, U-I core, E-I core or F core. However, the types of the first core member 10a and the second core member 10b may be determined according to practical applications, so the invention is not limited to the embodiment shown in the figure.

The at least one coil 12 may be wound around the inner leg 100 or the at least two outer legs 102. In this embodiment, the coil 12 may be wound around the inner leg 100, but the invention is not so limited. In another embodiment, the coil 12 may be wound around the at least two outer legs 102. In this embodiment, the second core member 10b is disposed on the first core member 10a and the inner leg 100 is bonded with the second core member 10b to form the bonding region 106. Furthermore, the second core member 10b is not bonded with the two outer legs 102, such that two non-bonding regions 104 are located between the two outer legs 102 and the second core member 10b. The type of the coil 12 may be a circular wire, a rectangular wire or a multi-stranded wire.

In this embodiment, the core 10 may be disposed in a casing 16 and the thermal conductive filler 14 is filled into the casing 16, such that the thermal conductive filler 14 covers a part of the core 10. At this time, at least one part of the at least one non-bonding region 104 is not covered by the thermal conductive filler 14. As shown in FIG. 1, the two non-bonding regions 104 and the bonding region 106 are not covered by the thermal conductive filler 14. Accordingly, the two outer legs 102 with the two non-bonding regions 104 can deform freely while the temperature difference (or max temperature) of the core 10 increases, such that the thermal stress of the core 10 can be reduced to prevent the loss of the core 10 from increasing. For example, for an inductor or a transformer with a power of 6.6 KW, the maximum thermal stress may be reduced from 68 MPa to 27 MPa and the maximum temperature of the core 10 may be reduced from 154° C. to 96° C. It should be noted that an inner plate surface 110 of the core 10 may be not covered by the thermal conductive filler 14.

In this embodiment, a thermal conductivity of the thermal conductive filler 14 may be greater than 0.3 W/mk, and a material of the thermal conductive filler 14 may comprise epoxy, silicone, polyurethane (PU), phenolic resins, thermoplastic polyethylene terephthalate (PET), polyamide (PA), polyphenylene sulfide (PPS), polyetheretherketone (PEEK) and so on.

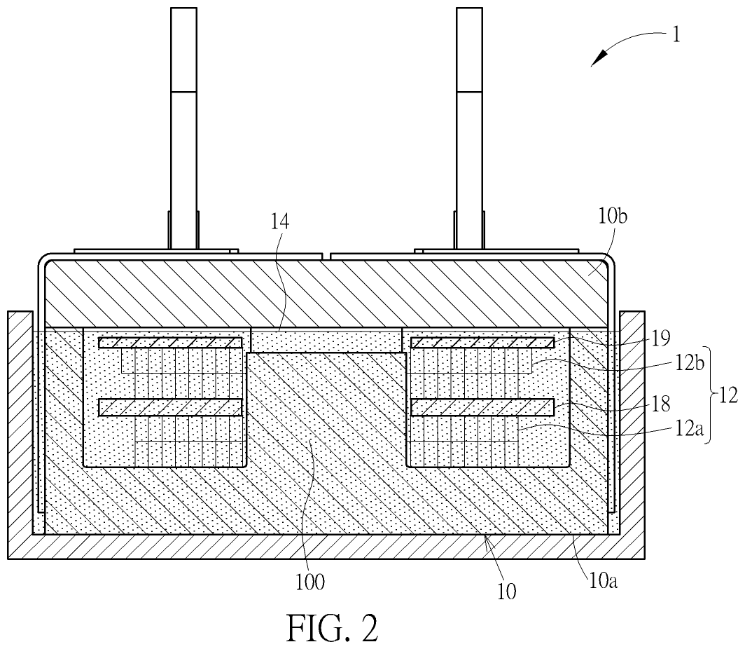

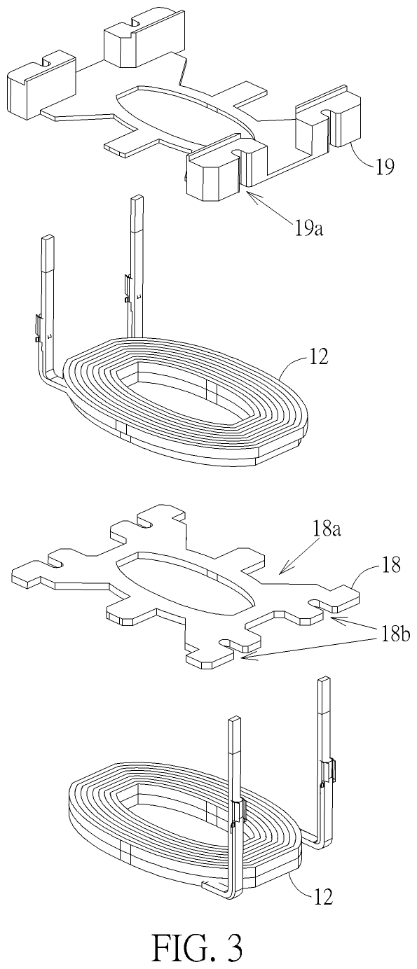

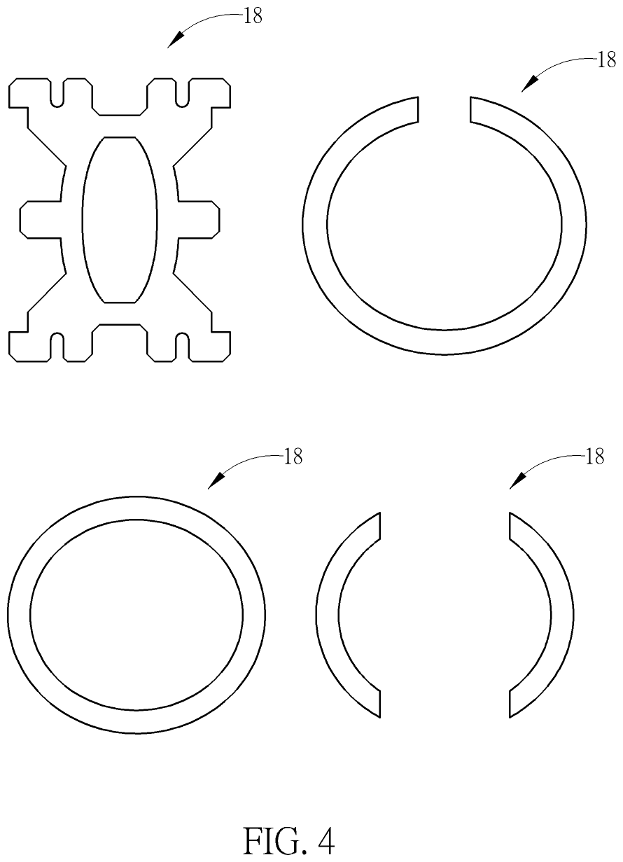

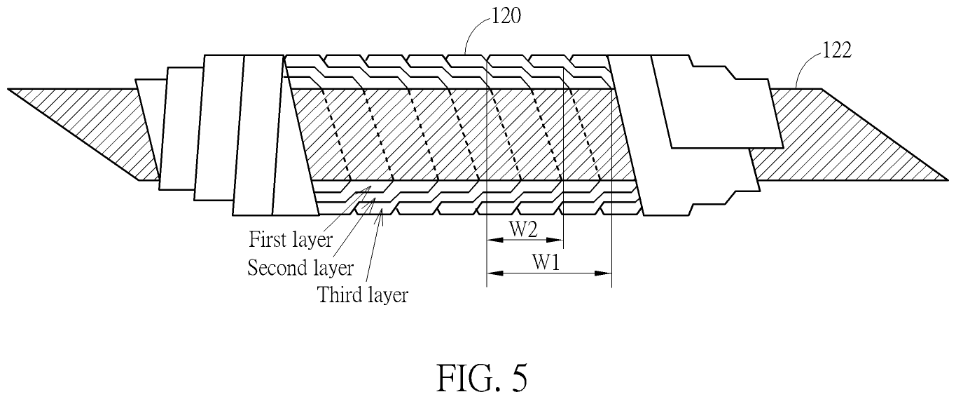

Referring to FIGS. 2 to 5, FIG. 2 is a sectional view illustrating the magnetic component 1 according to another embodiment of the invention, FIG. 3 is an exploded view illustrating a spacer 18, a coil cover 19 and two coils 12 shown in FIG. 2, FIG. 4 is a schematic view illustrating four spacers 18 indifferent shapes, and FIG. 5 is a schematic view illustrating a wire 122 covered by three misaligned layers of insulating tape 120. In some embodiments, the material of the spacer 18 is electrically insulating and magnetically permeable, or electrically insulating and thermal conductivity. For example, the spacer 18 may be made by injection molding after mixing magnetic powder and plastic, or made of a magnetic material (e.g. Ferrite), or made of a material with high thermal conductivity and electrical insulation (e.g. ceramic material). In this embodiment, the at least one coil 12 may comprise a primary coil 12a and a secondary coil 12b, and the cross-section thereof may be circular, elliptical or rectangular, wherein rectangle may effectively improve volume utilization. As shown in FIG. 4, the spacer 18 may comprise a ring-shaped structure (e.g. circular, elliptical, semicircular or semi-elliptical) disposed between the primary coil 12a and the secondary coil 12b. Accordingly, the leakage inductance (Lk) and the power density may be increased. Furthermore, the magnetic component 1 may further comprise a coil cover 19 directly sleeved on the inner leg 100 of the coil 10 and stacked above the spacer 18 and the two coils 12. The coil cover 19 is configured to lead an end of the coil 12 out of the core 10 through a guiding groove 19a. In this embodiment, the coil cover 19 is electrically insulating. In this embodiment, the spacer 18 further comprises a guiding groove 18b corresponding to the guiding groove 19a of the coil cover 19. When the spacer 18, the coil cover 19 and the two coils 12 are stacked with each other and directly sleeved on the inner leg 100 of the core 10, the end of the coil 12 is led out of the core 10 through the guiding groove 19a of the coil cover 19 and the guiding groove 18b of the spacer 18.

As shown in FIGS. 2 and 3, the magnetic component 1 may comprise a core 10, at least one spacer 18 and at least two coils 12, wherein the at least two coils 12 and the at least one spacer 18 are stacked with each other and directly sleeved on the inner leg 100. In this embodiment, the magnetic component 1 may comprises a spacer 18, a coil cover 19 and two coils 12 stacked with each other. The coils 12 do not need to be wound to a bobbin. After the coils 12 are wound into air coils, the coils 12 and the spacer 18 are stacked with each other and directly sleeved on the inner leg 100 of the core 10. In this embodiment, a winding structure of the coil 12 is led out from outer sides of upper and lower layers (outer-outer winding), which is different from another winding structure led out from inner sides (inner-outer winding) and has better flatness. Accordingly, the magnetic component 1 does not need to be limited by the size and space of the bobbin, and the spacers 18 may be tightly in contact with the coils 12, or a structure of the coil cover 19 may extend between two coils 12 to fix and minimize a distance and a gap between the spacer 18 and the coils 12, so as to minimize the size of the magnetic component 1. Since the space and size of the magnetic component 1 can be minimized, the heat dissipation path can be shortened and the magnetic component 1 does not have a structure (e.g. bobbin and coil cover having covering wall) covering the inner leg 100, so as to obtain good heat dissipation. In this embodiment, the spacer 18 has a void 18a. When the spacer 18 and the two coils 12 are stacked, the thermal conductive filler 14 may be filled into the void 18a between two opposite stacked surfaces of the two coils 12, the thermal conductive filler 14 may be filled into opposite surfaces between the inner leg 100 and the two coils 12, and the thermal conductive filler 14 may further cover outer surfaces of the two coils 12 and the spacer 18, so as to increase the heat dissipating surfaces of the two coils 12 and then obtain good heat dissipating effect. In some embodiments without the thermal conductive filler 14, since the spacer and the coil are not sleeved on a bobbin, the airflow is easier to enter the spacer 18, the coil cover 19 and the two coils 12, and a good heat dissipating effect can be obtained. In some embodiments, in order to maintain the same insulation between the two coils 12 and between the two coils 12 and the core 10 without a bobbin, each of the two coils 12 may be formed by winding a wire 122 covered by at least three misaligned layers of insulating tape 120 (as shown in FIG. 5). The single insulating tape 120 may be misaligned and stacked from first layer to at least second or third layer, and a misaligned overlap ratio W2/W1 is larger than 67%, wherein W1 represents a width of single insulating tape 120 and W2 represents an overlap width. The insulating tape 120 may be made of Polyimide Film. Preferably, single wire 122 or multiple wires 122 are enameled wires covered with an insulating layer.

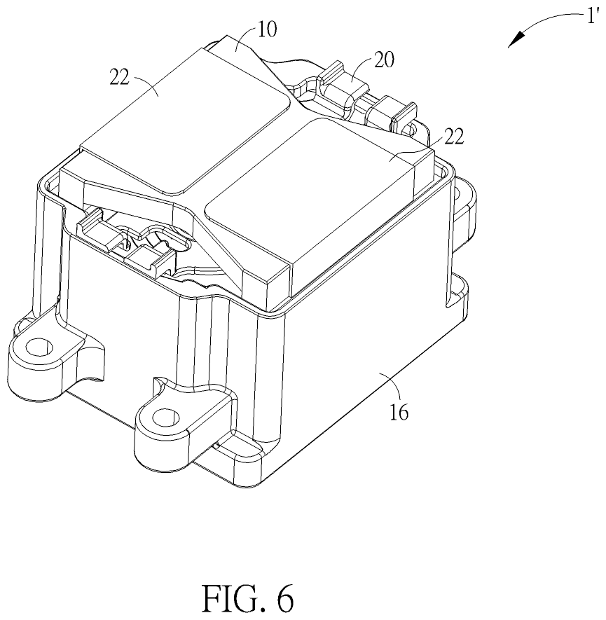

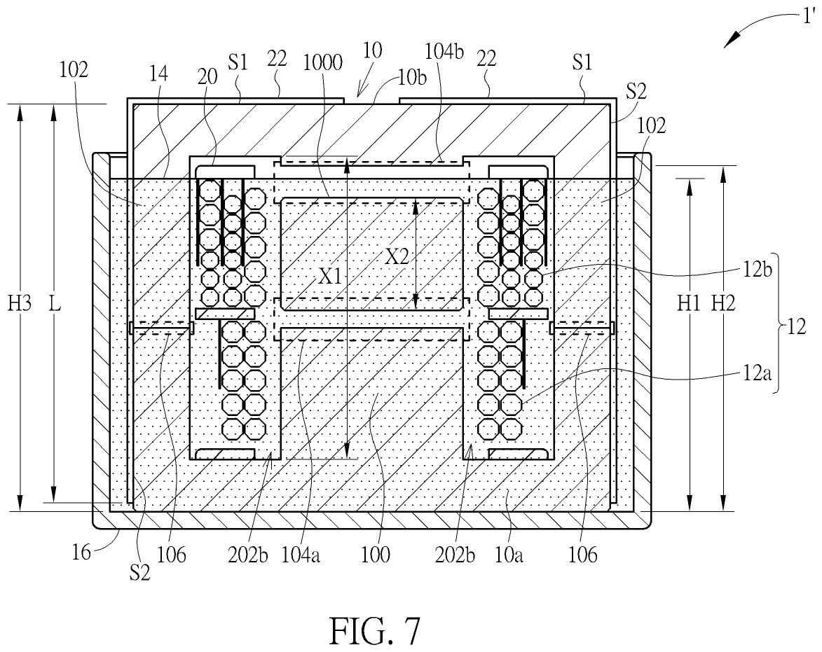

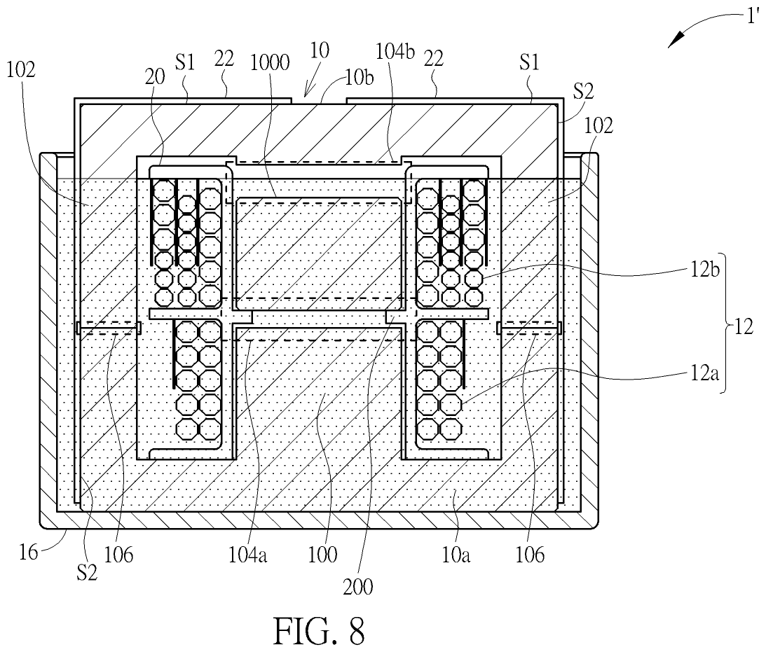

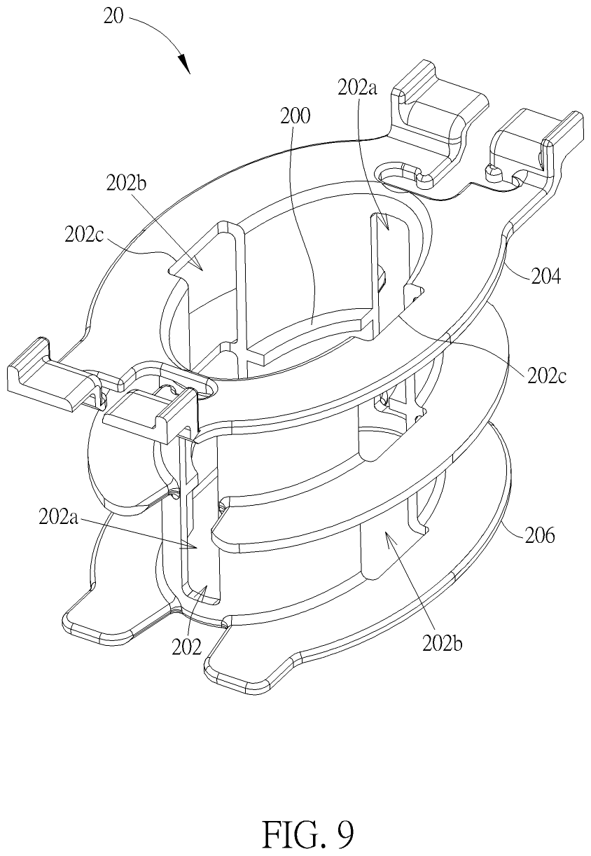

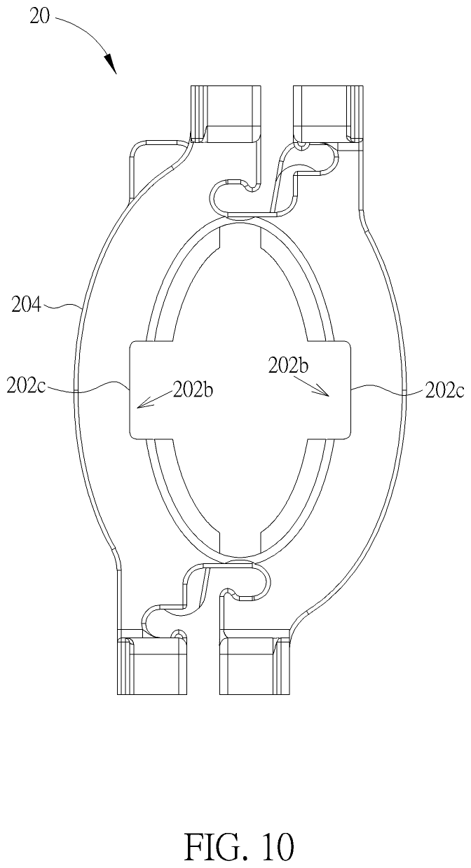

Referring to FIGS. 6 to 10, FIG. 6 is a perspective view illustrating a magnetic component 1′ according to another embodiment of the invention, FIG. 7 is a sectional view illustrating the magnetic component 1′ shown in FIG. 6, FIG. 8 is another sectional view illustrating the magnetic component 1′ shown in FIG. 6, FIG. 9 is a perspective view illustrating the bobbin 20 shown in FIG. 7, and FIG. 10 is a top view illustrating the bobbin 20 shown in FIG. 9.

The main difference between the magnetic component 1′ and the aforesaid magnetic component 1 is that the magnetic component 1′ further comprises a bobbin 20 and the inner leg 100 further comprises a floated portion 1000, as shown in FIGS. 6 to 9. In this embodiment, a proportion T of the floated portion 1000 to the inner leg 100 may be 50% or 2%˜95%. For further explanation, the inner leg 100 has a length X1 and the floated portion 1000 has a length X2, so the proportion T of the floated portion 1000 to the inner leg 100 is X2/X1. The bobbin 20 is sleeved on the inner leg 100 and the at least one coil 12 is disposed on the bobbin 20. Thus, the coil 12 is still wound around the inner leg 100. In this embodiment, an inside of the bobbin 20 has a protruding platform 200 and the floated portion 1000 of the inner leg 100 is supported by the protruding platform 200, such that the floated portion 1000 is located between the first core member 10a and the second core member 10b. In this embodiment, the protruding platform 200 may extend from outside to inside of the inner leg 100 to support the floated portion 1000.

In this embodiment, the first core member 10a and the second core member 10b are bonded with each other at the two outer legs 102 to form two bonding regions 106. Furthermore, the second core member is not bonded with the floated portion 1000 and the floated portion 1000 is supported by the protruding platform 200, such that two non-bonding regions 104a, 104b are located at opposite sides of the floated portion 1000. After the thermal conductive filler 14 is filled into the casing 16, one of the two non-bonding regions 104a, 104b are not (fully) covered by the thermal conductive filler 14. As shown in FIG. 7, the non-bonding region 104a below the floated portion 1000 and the two bonding regions 106 are covered by the thermal conductive filler 14 and the non-bonding region 104b above the floated portion 1000 is not covered by the thermal conductive filler 14. Accordingly, the inner leg 100 with the non-bonding region 104b can deform freely while the temperature difference (or max temperature) of the core 10 increases, such that the thermal stress of the core 10 can be reduced to prevent the loss of the core 10 from increasing.

In this embodiment, a height H1 of the thermal conductive filler 14 may be smaller than or equal to a height H2 of the bobbin such that the thermal conductive filler 14 is not in contact with a bottom surface of the second core member 10b. Thus, the thermal expansion stress of the thermal conductive filler 14 will be greatly reduced, and second core member 10b and the inner leg 100 will not interact with each other by higher thermal stress due to the thermal conductive filler 14, thereby reducing the temperature difference (or max temperature) of the core 10. Accordingly, the thermal stress of the core 10 can be reduced to prevent the loss of the core 10 from increasing.

As shown in FIGS. 7 and 9, at least one hole 202 may be formed on the bobbin 20 to enable the thermal conductive filler 14 to contact an inner side of the at least one coil 12 and increase a contact area between the thermal conductive filler 14 and the inner leg 100, so as to increase the heat dissipating path, effectively reduce the temperature difference (or max temperature), and then reduce additional loss due to heat. In this embodiment, one of the at least one hole 202 may extend from an upper plate 204 of the bobbin 20 to a lower plate 206 of the bobbin 20, and a boundary of the one of the at least one hole 202 may overlap at the upper plate 204 and the lower plate 206 of the bobbin 20. As shown in FIG. 9, the at least one hole 202 comprises two holes 202a and two holes 202b. The two holes 202b may extend from the upper plate 204 to the lower plate 206 of the bobbin 20, and the boundary 202c of each hole 202b may overlap at the upper plate 204 and the lower plate 206, as shown in FIGS. 9 and 10. Accordingly, the thermal conductive filler 14 is easier to flow into the bobbin 20, such that much heat may be conducted from the coil 12. Furthermore, the number of molds of manufacturing the bobbin (injection molding) is fewer, such that the cost may be reduced.

For example, when the magnetic component 1′ is an inductor or a transformer with a power of 5.5 KW and the proportion T of the floated portion 1000 to the inner leg 100 is 30%, the maximum thermal stress may be reduced from 52 MPa to 28.6 MPa and the maximum temperature of the core 10 may be reduced from 110° C. to 87.106° C. Although the temperature of the floated portion 1000 is 128.45° C., the floated portion 1000 is a simple column and will not crack. If further consideration is given to the winding position of the coil with a large cross-sectional area, the proportion of the floated portion 1000 to the inner leg 100 and the winding position of the coil with a large diameter are as follows. It should be noted that the at least one coil 12 may comprise a primary coil 12a and a secondary coil 12b, wherein the position of the secondary coil 12b corresponds to the floated portion 1000 and the position of the primary coil 12a corresponds to the inner leg 100 of the first core 10a. The primary coil 12a has a cross-sectional area D1 and the secondary coil 12b has a cross-sectional area D2. If the cross-sectional area D1 of the primary coil 12a is larger than the cross-sectional area D2 of the secondary coil 12b, the operation temperature of the primary coil 12a is larger than the operation temperature of the secondary coil 12b and the proportion T of the floated portion 1000 to the inner leg 100 may conform to 50%<T≤95%. If the cross-sectional area D1 of the primary coil 12a is smaller than the cross-sectional area D2 of the secondary coil 12b, the operation temperature of the secondary coil 12b is larger than the operation temperature of the primary coil 12a and the proportion T of the floated portion 1000 to the inner leg 100 may conform to 2%≤T<50%.

As shown in FIGS. 6 and 7, the magnetic component 1′ may further comprise a heat dissipating member 22 disposed on the core 10, wherein the heat dissipating member 22 is in contact with a top surface S1 and a side surface S2 of the core 10. In this embodiment, the magnetic component 1′ may comprise two heat dissipating members 22 disposed at opposite sides of the core 10, but the invention is not so limited. In this embodiment, the heat dissipating member 22 may be L-shaped and a length L of a portion of the heat dissipating member 22 in contact with the side surface S2 of the core 10 may be smaller than a height H3 of the core 10. Accordingly, even if the core 10 has a tolerance variation in height, the heat dissipating member 22 may keep in contact with the top surface S1 of the core 10 without gap, so as to enhance heat dissipation. Furthermore, since there are two heat dissipating members 22 attached to the top surface S1 and the side surface S2, the heat dissipating members 22 may be manufactured by a process with lower cost and higher tolerance. The L-shaped heat dissipating member 22 is not limited to a specific application and may also be applied in other embodiments.

In this embodiment, the thermal conductive filler 14 may cover a part of the heat dissipating member 22, such that the heat dissipating member 22 is able to conduct heat to the bottom. Furthermore, the heat dissipating member 22 may be adhered to the core 10 by a glue with Shore D or Shore A hardness smaller than 80, so as to reduce the temperature difference (or max temperature) of the core 10 and reduce the thermal stress. For example, if Shore D>80, the corresponding maximum temperature of the core 10 may be 59.3° C.; if Shore D<80, the corresponding maximum temperature of the core 10 may be reduced to 50.6° C.

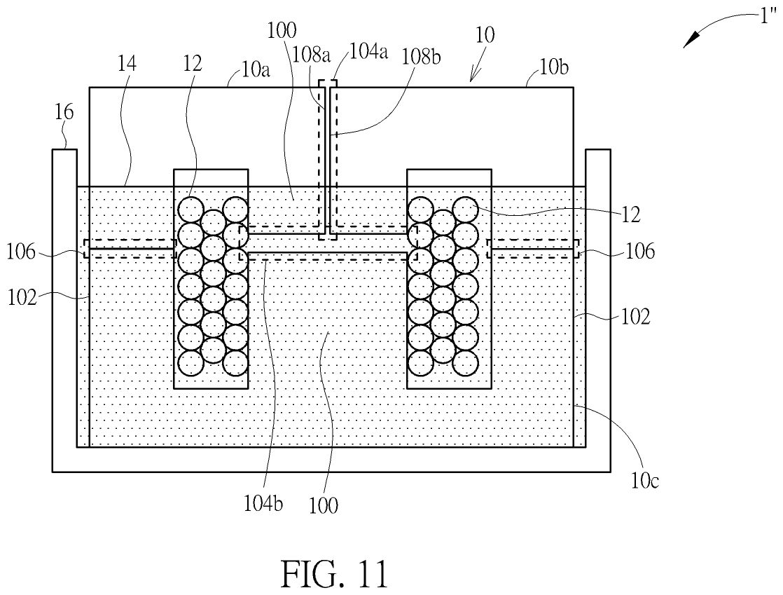

Referring to FIG. 11, FIG. 11 is a sectional view illustrating a magnetic component 1″ according to another embodiment of the invention.

The main difference between the magnetic component 1″ and the aforesaid magnetic component 1 is that, in addition to the first core member 10a and the second core member 10b, the magnetic component 1″ further comprises a third core member 10c. As shown in FIG. 11, the first core member 10a and the second core member 10b are arranged side by side and bonded with the third core member 10c at the two outer legs 102 to form two bonding regions 106. Furthermore, two neighboring side walls 108a, 108b of the first core member 10a and the second core member 10b are not bonded with each other, such that the non-bonding region 104a is located between the two neighboring side walls 108a, 108b of the first core member 10a and the second core member 10b. In this embodiment, the two neighboring side walls 108a, 108b form a part of the inner leg 100. The inner leg 100 of the third core member 10c and the inner leg 100 of the first core member 10a and the second core member 10b are disposed with respect to each other and not bonded, so as to form another non-bonding region 104b. The inner leg 100 of the third core member 10c is formed integrally without gap. The two neighboring side walls 108a, 108b of the first core member 10a and the second core member 10b are opposite to each other at the inner leg 100.

After the thermal conductive filler 14 is filled into the casing 16, at least one part of the non-bonding region 104a is not covered by the thermal conductive filler 14. As shown in FIG. 11, the lower part of the non-bonding region 104a between the two neighboring side walls 108a, 108b and the two bonding regions 106 are covered by the thermal conductive filler 14 and the upper part of the non-bonding region 104a is not covered by the thermal conductive filler 14. Furthermore, the non-bonding region 104b above the inner leg 100 of the third core member 10c is covered by the thermal conductive filler 14. Accordingly, the inner leg 100 with the upper part of the non-bonding region 104a can deform freely while the temperature difference (or max temperature) of the core 10 increases, such that the thermal stress of the core 10 can be reduced to prevent the loss of the core 10 from increasing. For example, when the magnetic component 1″ is an inductor or a transformer with a power of 3.7 KW, the maximum thermal stress may be reduced from 48 MPa to 16 MPa and the maximum temperature of the core 10 may be reduced from 150° C. to 120° C.

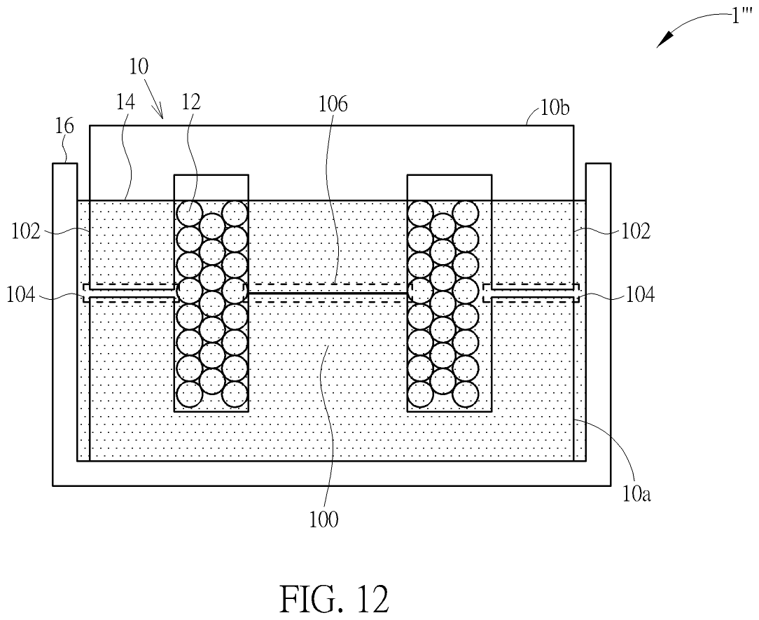

Referring to FIG. 12, FIG. 12 is a sectional view illustrating a magnetic component 1″ ‘ according to another embodiment of the invention.

The main difference between the magnetic component 1″’ and the aforesaid magnetic component 1 is that the thermal conductive filler 14 covers at least one non-bonding region 104, wherein the at least one non-bonding region 104 is located at the at least two outer legs 102, and at least one bonding region 106 is located at the inner leg 100, as shown in FIG. 12. In this embodiment, the first core member 10a and the second core member 10b are two of E core, PQ core, T core, UU core, U core, U-I core, E-I core, I core or F core, such that two non-bonding regions 104 are located at the two outer legs 102 and one bonding region 106 is located at the inner leg 100. In other words, the two outer legs 102 of the core 10 are not bonded and the inner leg 100 of the core 10 is bonded. After the thermal conductive filler 14 is filled into the casing 16, the thermal conductive filler 14 covers apart of the core 10, the two non-bonding regions 104 located at the two outer legs 102 and the bonding region 106 located at the inner leg 100. Accordingly, the two outer legs 102 with the non-bonding regions 104 can deform freely while the temperature difference (or max temperature) of the core 10 increases, such that the thermal stress of the core 10 can be reduced to prevent the loss of the core 10 from increasing. For example, when the magnetic component 1′″ is an inductor or a transformer with a power of 6.6 KW, the maximum thermal stress may be reduced from 68 MPa to 32.4 MPa and the maximum temperature of the core 10 may be reduced from 154° C. to 115.2° C.

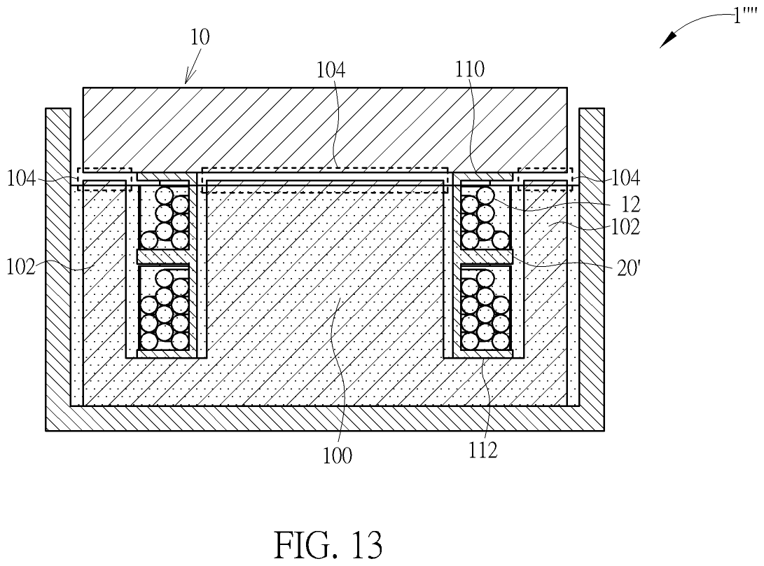

Referring to FIG. 13, FIG. 13 is a sectional view illustrating a magnetic component 1″″ according to another embodiment of the invention.

The main difference between the magnetic component 1″″ and the aforesaid magnetic component 1 is that, in addition to the core the at least one coil 12 and the thermal conductive filler 14, the magnetic component 1″″ further comprises a bobbin 20′, as shown in FIG. 13. The core 10 comprises an inner leg 100, at least two outer legs 102 and a plurality of non-bonding regions 104. The plurality of non-bonding regions 104 are located at the inner leg 100 and the at least two outer legs 102. The bobbin 20′ is sleeved on the inner leg 100. An upper surface 208 of the bobbin 20′ may be bonded to an inner plate surface 110 of the core 10 by adhesive. The at least one coil 12 is disposed on the bobbin 20′. After the thermal conductive filler 14 is filled into the casing 16, the thermal conductive filler 14 covers a part of the core 10 and does not cover the plurality of non-bonding regions 104. Accordingly, the inner leg 100 and the at least two outer legs 102 with the plurality of non-bonding regions 104 can deform freely while the temperature difference (or max temperature) of the core 10 increases, such that the thermal stress of the core 10 can be reduced to prevent the loss of the core 10 from increasing. In another embodiment, a lower surface 210 of the bobbin may be further bonded to another inner plate surface 112 of the core 10 by adhesive, wherein the two inner plate surfaces 110, 112 are opposite to each other.

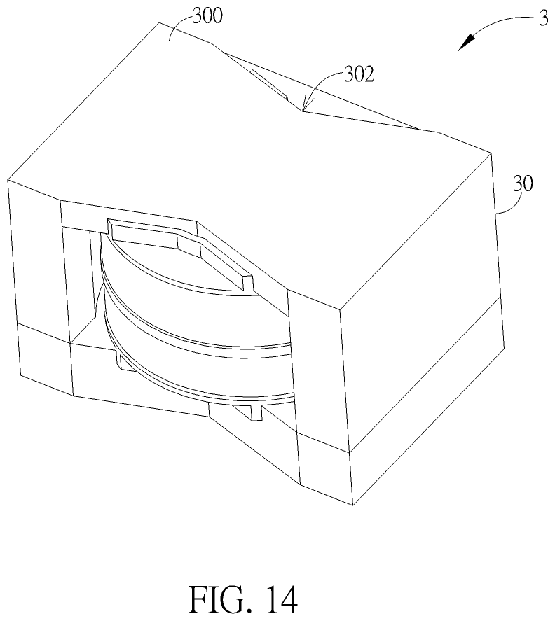

Referring to FIG. 14, FIG. 14 is a perspective view illustrating a magnetic component 3 according to another embodiment of the invention.

As shown in FIG. 14, the core 30 of the magnetic component 3 has a plate portion 300 and a V-shaped recess 302 is formed at an edge of the plate portion 300. In this embodiment, the edge of the plate portion 300 with the V-shaped recess 302 is a continuous edge without discontinuous geometry structure, so as to avoid stress concentration. In this embodiment, a position of a joint between two edges of the V-shaped recess 302 may correspond to the inner leg of the core 30.

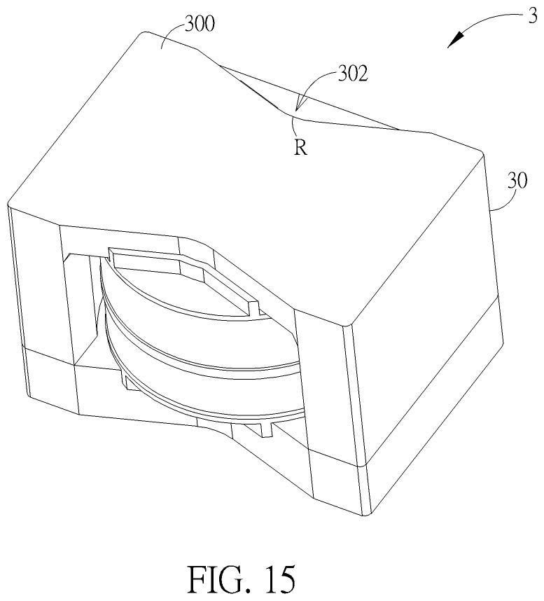

Referring to FIG. 15, FIG. 15 is a perspective view illustrating the magnetic component 3 according to another embodiment of the invention.

As shown in FIG. 15, a tip of the V-shaped recess 302 may have a radius R larger than 5, so as to avoid the V-shaped recess 302 being too sharp to affect the strength of the plate portion 300. For example, if the radius R is 0.8, the maximum thermal stress corresponding to the V-shaped recess 302 may be 85.6 MPa; if the radius R is 5, the maximum thermal stress corresponding to the V-shaped recess 302 may be reduced to 64.3 MPa. The core 30 with the V-shaped recess 302 and the radius R is not limited to a specific application and may also be applied in other embodiments.

As mentioned in the above, in an embodiment, the at least one non-bonding region may be located at the inner leg or the at least two outer legs, and at least one part of the at least one non-bonding region may not be covered by the thermal conductive filler. Accordingly, the inner leg or the at least two outer legs with the non-bonding region can deform freely while the temperature difference (or max temperature) of the core increases, such that the thermal stress of the core can be reduced to prevent the loss of the core from increasing. Furthermore, in another embodiment, the at least one non-bonding region may be located at the at least two outer legs, and the thermal conductive filler may cover the at least one non-bonding region or/and the bonding region located at the inner leg. Similarly, the at least two outer legs with the non-bonding region can deform freely while the temperature difference (or max temperature) of the core increases, such that the thermal stress of the core can be reduced to prevent the loss of the core from increasing. It should be noted that the temperature difference herein refers to the temperature difference between two different positions of the core at the same time. In another embodiment, the coil and the spacer may be stacked with each other and directly sleeved on the inner leg of the core, such that the coil does not need to be wound to a bobbin, so as to improve the effects of insulation and heat dissipation between the primary coil and the secondary coil and between the coil and the core. Accordingly, the magnetic component does not need to be limited by the size and space of the bobbin, and the spacer may be tightly in contact with the coil, or a structure of the coil cover may extend between two coils to fix and minimize a distance and a gap between the spacer and the coils, so as to minimize the size of the magnetic component.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a core comprising an inner leg, at least two outer legs and at least one non-bonding region;
at least one coil wound around the inner leg or the at least two outer legs; and
a thermal conductive filler covering a part of the core, at least one part of the at least one non-bonding region being not covered by the thermal conductive filler.

2. The magnetic component of claim 1, wherein an inner plate surface of the core is not covered by the thermal conductive filler.

3. The magnetic component of claim 1, further comprising a bobbin sleeved on the inner leg, wherein the at least one coil is disposed on the bobbin and a height of the thermal conductive filler is smaller than or equal to a height of the bobbin.

4. The magnetic component of claim 3, wherein at least one hole is formed on the bobbin to enable the thermal conductive filler to contact an inner side of the at least one coil and increase a contact area between the thermal conductive filler and the inner leg.

5. The magnetic component of claim 4, wherein one of the at least one hole extends from an upper plate of the bobbin to a lower plate of the bobbin, and a boundary of the one of the at least one hole overlaps at the upper plate and the lower plate of the bobbin.

6. The magnetic component of claim 1, wherein the core comprises a first core member and a second core member, the inner leg comprises a floated portion located between the first core member and the second core member, the first core member and the second core member are bonded with each other at the at least two outer legs, two non-bonding regions are located at opposite sides of the floated portion, and one of the two non-bonding regions are not covered by the thermal conductive filler.

7. The magnetic component of claim 6, wherein a proportion of the floated portion to the inner leg is 50% or 2%˜95%.

8. The magnetic component of claim 7, wherein the at least one coil comprises a primary coil and a secondary coil; wherein a cross-sectional area of the primary coil is larger than a cross-sectional area of the secondary coil, and the proportion T of the floated portion to the inner leg conforms to 50%<T≤95%.

9. The magnetic component of claim 7, wherein the at least one coil comprises a primary coil and a secondary coil; wherein a cross-sectional area of the primary coil is smaller than a cross-sectional area of the secondary coil, and the proportion of the floated portion to the inner leg conforms to 2%≤T<50%.

10. The magnetic component of claim 6, further comprising a bobbin sleeved on the inner leg, wherein the at least one coil is disposed on the bobbin, an inside of the bobbin has a protruding platform, and the floated portion of the inner leg is supported by the protruding platform.

11. The magnetic component of claim 10, wherein the protruding platform extends from outside to inside of the inner leg.

12. The magnetic component of claim 1, wherein the core comprises a first core member and a second core member, the inner leg and the at least two outer legs extend from the first core member, the inner leg is bonded with the second core member, and the at least one non-bonding region is located between the at least two outer legs and the second core member.

13. The magnetic component of claim 1, wherein the core comprises a first core member, a second core member and a third core member, the first core member and the second core member are arranged side by side and bonded with the third core member at the at least two outer legs, the at least one non-bonding region is located between two neighboring side walls of the first core member and the second core member, and the two neighboring side walls form a part of the inner leg.

14. The magnetic component of claim 13, wherein the inner leg of the third core member and the inner leg of the first core member and the second core member are disposed with respect to each other and not bonded, the inner leg of the third core member is formed integrally, and the two neighboring side walls of the first core member and the second core member are opposite to each other at the inner leg.

15. The magnetic component of claim 1, wherein the core has a plate portion and a V-shaped recess is formed at an edge of the plate portion.

16. The magnetic component of claim 15, wherein a position of a joint between two edges of the V-shaped recess corresponds to the inner leg.

17. The magnetic component of claim 15, wherein a tip of the V-shaped recess has a radius larger than 5.

18. The magnetic component of claim 1, further comprising a heat dissipating member disposed on the core, wherein the heat dissipating member is in contact with a top surface and a side surface of the core.

19. The magnetic component of claim 18, wherein the heat dissipating member is L-shaped and a length of a portion of the heat dissipating member in contact with the side surface of the core is smaller than a height of the core.

20. The magnetic component of claim 18, wherein the thermal conductive filler covers a part of the heat dissipating member.

21. The magnetic component of claim 18, wherein the heat dissipating member is adhered to the core by a glue with Shore D or Shore A hardness smaller than 80.

22. The magnetic component of claim 1, further comprising at least one spacer sleeved on the inner leg, wherein the at least one coil and the at least one spacer are stacked with each other.

23. The magnetic component of claim 1, wherein the at least one coil comprises a primary coil and a secondary coil, a material of the spacer disposed between the primary coil and the secondary coil is electrically insulating and magnetically permeable, and the spacer comprises a ring-shaped structure disposed between the primary coil and the secondary coil.

24. A magnetic component comprising:
a core comprising an inner leg, at least two outer legs and at least one non-bonding region, the at least one non-bonding region being located at the at least two outer legs;
at least one coil wound around the inner leg or the at least two outer legs; and
a thermal conductive filler covering a part of the core and the at least one non-bonding region located at the at least two outer legs.

25. A magnetic component comprising:
a core comprising an inner leg, at least two outer legs and a plurality of non-bonding regions, the plurality of non-bonding regions being located at the inner leg and the at least two outer legs;
a bobbin sleeved on the inner leg, an upper surface of the bobbin being bonded to an inner plate surface of the core;
at least one coil disposed on the bobbin; and
a thermal conductive filler covering a part of the core and not covering the plurality of non-bonding regions.
